(19) United States
(12) Patent Application Publication
(10) Pub. No.: US 2025/0138969 A1
(43) Pub. Date: May 1, 2025

(54) SYSTEM AND METHOD FOR DETERMINING AN OPTIMIZATION OPPORTUNITY IN REQUEST PERFORMANCES

(71) Applicant: R.C.Raven Cloud LTD, Tel Aviv-Yafo (IL)

(72) Inventors: Roi ABITBOUL, Mountain View, CA (US); Guy FRANCO, Tel Aviv (IL); Yanna GOTTLIEB, Tel Aviv (IL); Omer YAIR, Ramat Gan (IL)

(73) Assignee: R.C.Raven Cloud LTD, Tel Aviv-Yafo (IL)

(21) Appl. No.: 18/496,153

(22) Filed: Oct. 27, 2023

(51) Int. Cl. G06F 11/30; G06F 11/34

(52) U.S. Cl. CPC G06F 11/3072; G06F 11/3452

(57) ABSTRACT

A system and method for determining an optimization opportunity in request performances is presented. The method includes extracting a first event with an inherent delay and a first thread of a request including the first event, wherein the inherent delay is identified by monitoring a duration of the first event above a threshold percentile; determining an event contribution for at least one second event that is an event of at least one second thread of the request, wherein the event contribution is determined for a request occurrence; statistically determining an event performance for each of the at least one second event based on aggregated event contributions for the at least one second event; identifying an optimization opportunity for the request based on the event performance beyond a predefined range; and generating a report to include identified optimization opportunity for the request.

### TECHNICAL FIELD

The present disclosure relates generally to cloud computing and, in particular, to systems and methods for determining an optimization opportunity in request performances at runtime.

### BACKGROUND

Cloud computing refers to the delivery of various services over the internet. These services include storage, databases, servers, networking, software, analytics, intelligence, and more. Cloud computing offers faster innovation, flexible resources, and economies of scale.

Infrastructure as a Service (IaaS) is the most basic category of cloud computing services. With IaaS, you rent IT infrastructure—servers and virtual machines, storage, networks, operating systems—on a pay-as-you-go basis. Cloud resources cost refers to the expenses associated with using various services and infrastructure provided by cloud computing vendors. These costs can vary significantly based on numerous factors. Such factors include the type of resource, and the usage of the resource, a region where the resource is deployed, and so on. The cost of cloud resources is a significant expense of companies providing SaaS over cloud infrastructure.

Traditional ways to reduce costs include, for example and without limitation, using saving plans, changing resource types to reserve from on-demand instances, and the like, and more, as some providers offer options to reserve instances for a longer-term, often at a reduced rate compared to on-demand pricing. Other approaches for reducing costs include resizing an instance (e.g., reducing compute power or memory of an instance). Yet another approach for reducing is a spot instance. A spot instance in cloud computing refers to a temporary, on-demand computing capacity that can be obtained at a significant discount compared to regular on-demand instances. Spot instances allow you to use spare computing capacity in a cloud provider's data center.

Though such techniques may offer some savings, these do not address the core problems of close compute power which include the bottleneck in execution of software. For example, an unoptimized piece of code may consume unnecessary computing power, thereby increasing the utilization of instances of cloud resources, which in return increases the overall cost. To this end, methods to optimize the bottlenecks in the workload (e.g., application, service, tasks, etc.) are desired for efficient processing, use of resources, and budget management.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for determining an optimization opportunity in request performances. The method comprises: extracting a first event with an inherent delay and a first thread of a request including the first event, wherein the inherent delay is identified by monitoring a duration of the first event above a threshold percentile; determining an event contribution for at least one second event that is an event of at least one second thread of the request, wherein the event contribution is determined for a request occurrence; statistically determining an event performance for each of the at least one second event based on aggregated event contributions for the at least one second event; identifying an optimization opportunity for the request based on the event performance beyond a predefined range; and generating a report to include identified optimization opportunity for the request.

Certain embodiments disclosed herein also include a non-transitory computer readable medium having stored thereon causing a processing circuitry to execute a process, the process comprising: extracting a first event with an inherent delay and a first thread of a request including the first event, wherein the inherent delay is identified by monitoring a duration of the first event above a threshold percentile; determining an event contribution for at least one second event that is an event of at least one second thread of the request, wherein the event contribution is determined for a request occurrence; statistically determining an event performance for each of the at least one second event based on aggregated event contributions for the at least one second event; identifying an optimization opportunity for the request based on the event performance beyond a predefined range; and generating a report to include identified optimization opportunity for the request.

Certain embodiments disclosed herein also include a system for determining an optimization opportunity in request performances. The system comprises: a processing circuitry; and a memory, the memory containing instructions that, when executed by the processing circuitry, configure the system to: extract a first event with an inherent delay and a first thread of a request including the first event, wherein the inherent delay is identified by monitoring a duration of the first event above a threshold percentile; determine an event contribution for at least one second event that is an event of at least one second thread of the request, wherein the event contribution is determined for a request occurrence; statistically determine an event performance for each of the at least one second event based on aggregated event contributions for the at least one second event; identify an optimization opportunity for the request based on the event performance beyond a predefined range; and generate a report to include identified optimization opportunity for the request.

Certain embodiments disclosed herein include the method, non-transitory computer readable medium, or system noted above, wherein the request is executed by a workload deployed in a cloud computing platform.

Certain embodiments disclosed herein include the method, non-transitory computer readable medium, or system noted above, further including or being configured to perform the following steps: aggregating the event contributions of the at least one second event from a plurality of request occurrences, wherein aggregating is based on a predefined rule.

Certain embodiments disclosed herein include the method, non-transitory computer readable medium, or system noted above, wherein the predefined rule includes at least one of: a request type, an event type, and a predefined time period.

Certain embodiments disclosed herein include the method, non-transitory computer readable medium, or system noted above, wherein the report includes at least one of: a request performance, an event performance, a bottleneck event, an optimization opportunity, a performance degradation, and potential cost savings.

Certain embodiments disclosed herein include the method, non-transitory computer readable medium, or system noted above, further including or being configured to perform the following steps: mapping the request including a plurality of events, the first thread, and the at least one second thread, wherein the plurality of events includes the first event and the at least one second event.

Certain embodiments disclosed herein include the method, non-transitory computer readable medium, or system noted above, wherein the first thread and the at least one second thread are different threads of the request.

Certain embodiments disclosed herein include the method, non-transitory computer readable medium, or system noted above, wherein the event contribution is determined as a ratio between a predicted time and an actual time of a request performance.

Certain embodiments disclosed herein include the method, non-transitory computer readable medium, or system noted above, wherein the event performance includes at least one of: an average, a median, a maximum, and a minimum.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for determining performance and optimization of a request according to an embodiment.

FIG. 3 is a flowchart illustrating a method for analyzing an event performance for at least one event in the request according to an embodiment.

FIG. 4 is a schematic diagram illustrating a request map according to an example embodiment.

FIG. 5 is a schematic diagram of an analyzer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for determining performance of events by monitoring requests in a service. The runtime requests and events of the service are continuously monitored and corresponding data are collected for analysis of the request performance such as, latency, throughput, and the like. Various delays such as, without limitation, context switching, network delays, and the like, that are inherent to running of the system are utilized to discover the bottlenecks in execution of services in the cloud resources. In an embodiment, impacts of the unoptimized (or bottleneck) functions on the execution may be determined and further utilized to determine potential optimization opportunities. In a further embodiment, the such bottleneck functions (or optimization opportunities) are identified through statistical analyses of event contributions that are collected and determined during, for example, a period of time.

The disclosed embodiments utilized a native randomness of the service that include inherent delays during execution of a workload at the instance of a resource. To this end, deliberate modification of functions is not necessary, thereby removing interferences and additional code to be deployed at the instance. According to the disclosed embodiments, the execution of workloads (or requests) is monitored without special instructions to reduce interruption and processing time of the computing resources. It should be appreciated that such efficient identification of optimization opportunities using runtime data does not add additional burden on the cloud resources and thus, conserve computing power.

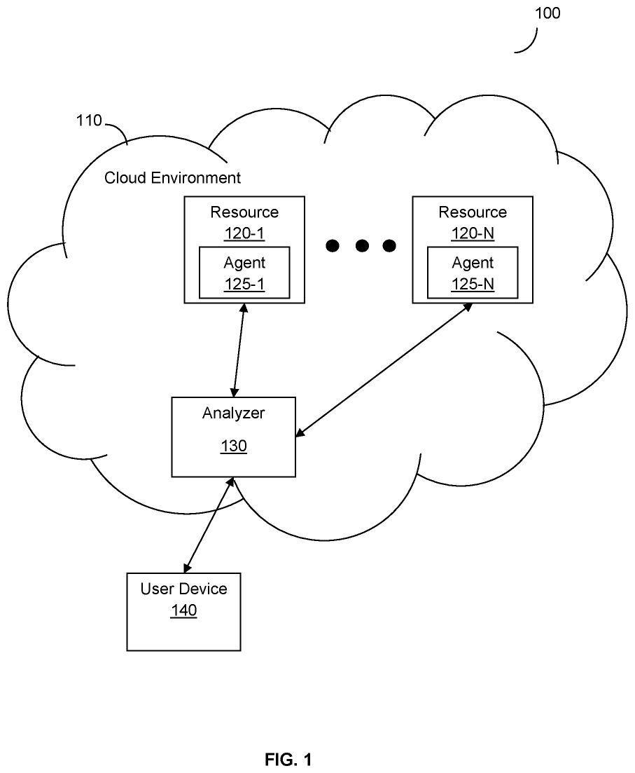

FIG. 1 shows an example cloud diagram 100 utilized to describe the various disclosed embodiments. In the example cloud diagram 100, a plurality of cloud resources 120-1 through 120-N (hereinafter referred to individually as a resource 120 and collectively as resources 120, merely for simplicity purposes), a plurality of agents 125-1 through 125-N (hereinafter referred to individually as an agent 125 and collectively as agents 125, merely for simplicity purposes), and an analyzer 130 communicates within a cloud environment 110. Moreover, the example cloud diagram 100 includes a user device 140 that communicates with the analyzer 130 over a network.

The network may include, but not limited to, a wireless, cellular or wired network, a local area network (LAN), a wide area network (WAN), a metro area network (MAN), the Internet, the worldwide web (WWW), similar networks, and any combination thereof. In some embodiments, the analyzer 130 may be installed outside of the cloud environment 110 and communicated via the network.

The cloud environment 110 may be, but is not limited to, a public cloud, a private cloud, or a hybrid cloud. A public cloud is owned and operated by a third-party service provider that delivers computing resources for use over the internet, whereas a private cloud is cloud computing resources that are exclusively used by a single business or an organization. A hybrid cloud combines the public cloud and the private cloud that allows data and application sharing between both types of computing resources. Some examples of a cloud environment 110 may include, and without limitation, Amazon Web Services (AWS), Microsoft® Azure, Google Cloud Platform (GCP), and the like, which may also be referred to as cloud providers.

The user device (UD) 140 may be, but is not limited to, a personal computer, a laptop, a tablet computer, a smartphone, a wearable computing device, or any other device capable of receiving and displaying notifications. The user device 140 may receive analysis reports generated at the analyzer 130 via a graphical user interface (GUI) such as, but not limited to, a dashboard. The analysis report describes performances of requests, event performances, and resource utilizations for executing the workloads including, for example, but not limited to, monitored services, bottleneck events and/or functions, one or more optimization opportunities, performance degradation, cost savings upon optimization, and more, and any combination thereof.

The cloud resources 120 are virtual components or capabilities that are provided by the cloud environment 110 to perform workloads. The resources may be rapidly provisioned and released with minimal management effect and are accessible over the internet. The cloud resource 120 may be configured to perform requests of one or more workloads (e.g., service, application, etc.) at instances that are used on-demand based on the need for processing workloads. Simultaneous processing of workloads and requests is continuously performed in the cloud resource 120, which may cause interdependencies in request performances. It should be noted that efficient usage of instances and resources 120 as a whole is desired to reduce cost and further to conserve computing resources at, for example, the cloud resources 120.

Each of the cloud resources 120 is configured with an agent 125 (which may be realized as a piece of code stored in a memory and executed over a process of the cloud resource 120) to monitor the workload at an instance of the resource 120. The agent 125 is configured to collect raw data on the events, for example, but not limited to, opening a file, sending over a network, sending data over a socket, and the like, and corresponding call stack, in executing the service (or application). The call stack is a data structure that keeps track of active events (or functions) within the workload. In an embodiment, the agent 125 is a code that runs in the kernel of the operating system and provides the collected data to the analyzer 130. In a further embodiment, the agent 125 may run in a user mode by, for example, but not limited to, dynamically instrumenting the application code, using specific operation system (OS) functionalities (e.g., ptrace, etc.), or the like, and more. In an embodiment, the collected data is stored in a memory or on a disk at the resource 120. In some implementations, the collected data is stored in a database (not shown) in the cloud environment 110 which may be retrieved for further analysis at the analyzer 130.

The analyzer 130 is a component, device, and the like, in the cloud environment 110 that processes raw data and call stacks to determine performance of requests as well as for events (or functions) executed in a workload. In an embodiment, the request performance may include, for example, but not limited to, latency, throughput, and the like. The analyzer 130 is configured to identify requests for the service and analyzes performance of events (or functions) within the request. The analyzer 130 is further configured to determine contribution of at least one event on the performance of the request and to identify events that may be optimized to improve the request as a whole. The terms event and functions are used interchangeably herewith to describe the function that executes the event. In an embodiment, such identified event, that is unoptimized, may be determined as a bottleneck event and an optimization opportunity. It should be noted that such optimization of the bottleneck event to improve request performances allows more efficient utilization of instances and its resources 120, which further reduces computational power and costs for processing workloads at resources 120.

In an embodiment, the analyzer 130 is configured to analyze request data that is monitored and collected via the agent 125 during regular runtime. In such a scenario, no intentional modification of the event or request is performed for analysis and instead, the inherent delays caused at one or more functions due to native randomness of the system are utilized to identify functions that effect request performances. The analyzer 130 is further configured to perform a statistical analysis of event performances analyzed for a wide range of request scenarios. In an embodiment, a function that causes lower request performance (i.e., longer request latency, lower request throughput, etc.) is identified as an optimization opportunity or a bottleneck function. The inherent delays that cause delay in a certain event or function are, for example, but not limited to, context switching, network delays, and the like. The analyzer 130 may receive request data for multiple request occurrences (or incidents of request) that varies in request type, delayed event type, and the like, and more, which may be concurrently analyzed.

In an embodiment, the analyzer 130 is configured with or is communicatively connected to a database (not shown). The database stores performance data (e.g., latency, throughput, and the like) for at least one request as well as corresponding event contributions and event performances. Statistical analysis of the event performance data may be performed to determine, for example, and without limitation, median, average, maximum, minimum, range, and the like. In an example embodiment, the statistical analysis may be performed for event contributions collected within a predetermined time period. As an example, the event performance may be determined for event contributions determined within 5 minutes. In some embodiments, the statistically analyzed performance data may be stored as predetermined performance data. It should be noted that the predetermined performance data may be updated with continued analysis of requests and stored at the database (not shown).

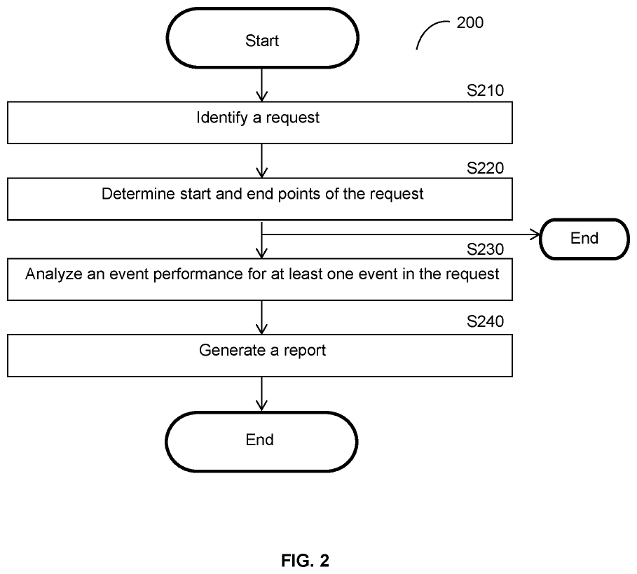

FIG. 2 is an example flowchart 200 illustrating a method for determining performance and optimization of a request according to an embodiment. The method described herein may be performed at the analyzer 130, FIG. 1, which may be configured in or outside a cloud environment 110, FIG. 1. It should be noted that the method is described with respect to a single request for simplicity and without limiting the scope of the disclosed embodiments. The method may be performed for a plurality of requests simultaneously, consecutively, or the like.

At S210, a request is identified. The request for a workload (e.g., task, application, service, etc.) includes one or more threads, each tread may include a sequence of functions to perform the workload. In an embodiment, the request may be identified as an event pattern that is monitored by the agent (e.g., the agent 125, FIG. 1) and reported to the analyzer (e.g., the analyzer 130, FIG. 1).

At S220, start and end points of the request is determined. The raw data and call stacks of the requests are received and utilized to determine the start and end points as well as to measure the latency of the request. The latency is the time taken to process the request from the start point and the end point. The raw data and the call stacks are received from the agent (e.g., the agent 125, FIG. 1). The raw data includes, for example, but not limited to, system calls, input/output (I/O) operations, CPU performance counter events, memory operations, synchronization operation, and the like of functions (events) executed in the request. The call stacks are associated with the request and define the active functions at different times within the request.

In an embodiment, upon determination that the request latency is greater than a predefined threshold percentile, the operation continues to S230. Otherwise, the operation ends for the request. In an example embodiment, the predefined threshold percentile is 75th, which includes requests with request latencies greater than a predetermined median latency for the request (i.e., slower processing of request). In an embodiment, a request latency below the predefined threshold percentile is considered as having acceptable performance and further optimization may not be desired. In an embodiment, a throughput (i.e., number of output of requests per time) of consecutive occurrences of the request over a predefined time period may be utilized to compare against the predefined threshold percentile. In some implementations, aggregated request latency and/or throughput determined over time is utilized to determine whether the request performance is acceptable or needs further optimization.

The steps of S210 to S220 are performed for each request that is identified through monitoring of events. The latency and throughput measured for requests (i.e., request performances) are aggregated to determine various threshold values, for example, a distribution, median, average, minimum, maximum, and the like, of the request performances. In an embodiment, such various threshold values may be stored in a database of the analyzer (e.g., the analyzer 130, FIG. 1).

At S230, an event performance for an event in the request is analyzed. The event performance is determined for each event in the request through statistical analysis of event contributions in multiple occurrences of the request. Such event performance indicates the effect of the corresponding event on the request performance such as, but not limited to, latency, throughput, and the like. To this end, the event performance suggests an optimization opportunity of the request and may further identify a bottleneck event (or function) of the request. The optimization opportunity indicates portions of the request (i.e., events or functions) that may be modified to improve performance of the request, thereby improving the utilization of computing resources of, for example, the cloud computing platform.

In an embodiment, inherent delays such as, but not limited to, context switching, network delay, and the like, and any combination thereof, in the resources when handling the workload are employed to calculate virtual speed up of certain functions. It should be noted that the inherent delays occur during routine runtimes of the workload and/or request. To this end, additional involvement to create a slowdown of certain functions, and thus events, is eliminated.

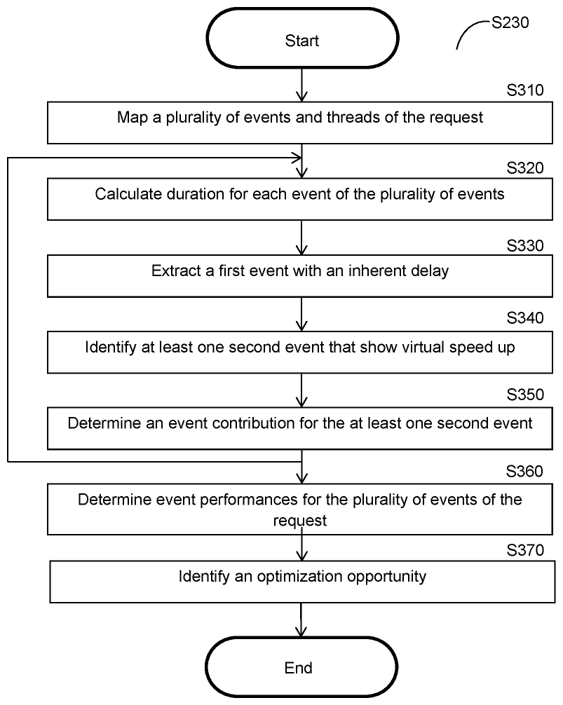

In an embodiment, the aggregated event contributions from multiple request occurrences are utilized to determine event performance of a specific event. A statistical analysis is performed on the aggregated data to accurately account for different runtime conditions including, for example, interdependencies between functions, active functions, and the like, and more. The performances of each event may be aggregated for a plurality of requests that are processed over a predefined period of time. In an example embodiment, an event is determined to be underperforming and a bottleneck upon determination that the performance data is beyond a predefined range. As an example, an event is determined to be underperforming when the statistically determined duration of the event is above the predefined 75th percentile of performance data collected for the specific event. In another example, the event is determined to be a bottle when the event is above the 75th percentile range, 75th percentile or greater, based on its performance. In a further example embodiment, the event is determined to be optimized (or acceptable) upon determination that the performance data is below predefined threshold. As an example, an event is identified to be optimized when the performance data (or duration) is below a 25th percentile of the specific event's performance data. The method to analyze the performance data is described in detail in FIG. 3 below.

At S240, a report is generated. The report describes the results of analyzing an event performance for the at least one event and may include, for example, but not limited to, monitored workload, instance, resources, and the like, bottleneck event and/or functions, degree of performance degradation, optimization opportunity, suggestions for optimization, cost saving upon optimization, and more, and any combination thereof. The optimization of the request and/or bottleneck event may include, without limitation, parallelizing the event, changing or optimizing data structure that the function utilizes, caching the results, and the like, and any combination thereof. In some embodiments, suggestions for optimization may include adding additional compute resources to support the execution of the function. In some implementations, the report may be generated upon identifying an optimization opportunity based on the event performance, for example, that is below a predetermined threshold value. The report may be caused to be displayed via a user device (e.g., the user device 140, FIG. 1). In an embodiment, the report may be generated periodically at predetermined time intervals preset by, for example, a user. It should be noted that modification and/or optimization of the identified optimization opportunity enables improved performance and utilization of cloud resources.

FIG. 3 is an example flowchart S230 illustrating a method for analyzing an event performance for an event in the request according to an embodiment. The process of analyzing the event performance is described for one type of request that displays the same event pattern. The method described herein may be performed at an analyzer 130, FIG. 1.

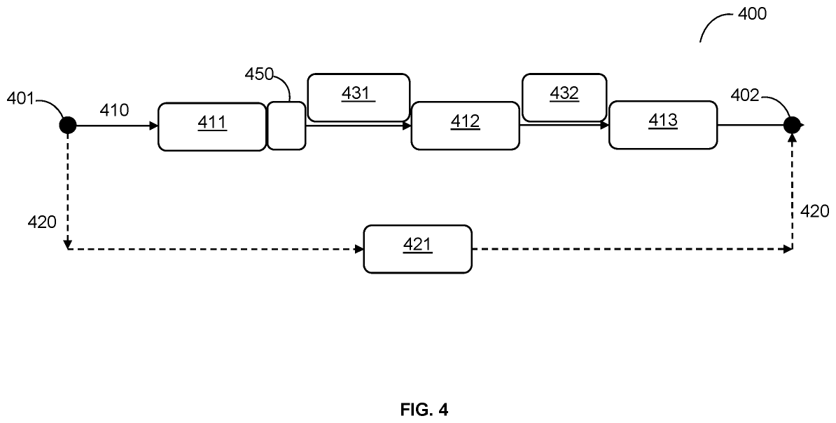

At S310, a plurality of events and one or more threads of the request are mapped. The distinct pattern of events for the request is mapped to include a plurality of events distributed amongst one or more threads. The event is, for example, but not limited to, opening a connection to a socket, opening a file, sending over a network, holding a multi exclusion (mutex) object, waiting on a mutex, sending data over a socket, and more. An example request map including the plurality of events, period between the events, and one or more threads are shown below in FIG. 4. It should be noted that each of the plurality of events may include one or more functions to be executed for processing the workload. It should be noted that the terms event and functions are used interchangeably herewith to describe the function that executes the event.

According to the disclosed embodiments, the following operations from S320 through S350 are performed for every occurrence of the mapped request during runtime. Thus, the operations are performed for each single occurrence of the request. It should be noted that the occurrence of the mapped request is monitored and tracked without deliberate interference and execution. It should be further noted that such a process may be simultaneously and continuously performed for a plurality of request occurrences.

At S320, duration for each event of the plurality of events is calculated. The duration for each event is the time taken to complete each event. As an example, duration for an event to send data over the network is a time taken from beginning to send data to completing to send data. The duration may also be determined for the period between the events and for functions within the event. The durations for the plurality of events are calculated for a single occurrence (or incident) of the request being performed for the workload. A call stack that defines active functions in combination with a centralized processing unit (CPU) performance counter are utilized to track time of functions and/or events. Such tracking of time may be employed for calculating the duration of each event. In an example embodiment, a CPU performance counter may be turned on, for example, every 20 milliseconds, to identify currently active functions of the events. The various status of functions and/or events in the request (e.g., start, end, or active functions, start and end of event, transfer time between events, etc.) may be continuously monitored by, for example, an agent (e.g., the agent 125, FIG. 1).

At S330, a first event with an inherent delay is extracted. The first event is identified based on corresponding first duration that is equal or above a predefined threshold. In an example embodiment, the predefined threshold may be a 75th percentile so that events, displaying durations equal and above the 75th percentile, are identified as the first events that experience the inherent delay. In an embodiment, the predefined thresholds may be defined based on various duration parameters, for example, but not limited to, distribution, maximum, minimum, median, average, and the like, of the first event. In an application process, a first thread in the request includes at least the first event. In some cases, one or more first events may be identified and extracted due to the nature of the inherent delays that are randomly created during the runtime of the workload. The inherent delays are not individually controlled and thus, additional processing is unnecessary. Moreover, it should be noted that such randomness provides analysis of a wide range of potential scenarios (e.g., delays) that may occur during execution of the request, which can be burdensome to controlled modification and analysis.

In an embodiment, the first event may be extracted based on a first transfer time that is equal to or above the predefined threshold. As an example, when the first transfer time between ending of the first event and starting of a following event is greater than the median time for that transfer period, the first event has experienced the inherent delay and thus, extracted. The inherent delay may be, for example, but not limited to, context switching, network delay, and the like, that is randomly generated during processing of the workload. Distinguishing the inherent delay by the type of delay may not be necessary.

At S340, at least one second event that experiences a virtual speed up is identified. The at least one second event of the plurality of events of the request and belongs to a thread other than the first thread. That is, the at least one second event and the first event is not part of the same thread. In an embodiment, the at least one second event experiences a virtual speed up based on the inherent delay deployed at the first event of the first thread.

At S350, an event contribution is determined for the at least one second event. The event contribution (or simply, contribution) defines a magnitude of effect the second event (i.e., the event with a virtual speed up) has on the request performance (e.g., latency, throughput, etc.) in this single request occurrence. The single request occurrence is one execution incident of the request including the first event and the at least one second event (also the request that was mapped in S310).

In an embodiment, the contribution of the at least one second event is determined based on a predicted time and an actual time of the request performance. In a further embodiment, the determined contribution is assigned uniformly to all of the at least one second event so that the at least one second event of the request occurrence has the same contribution. The predicted time (or baseline time) is a time that is expected for the request performance when no delay and/or speed up of events are present during execution. The predicted time may be determined from a plurality of request occurrences when under such condition. The actual time is the request performance measured for the corresponding request occurrence. As noted above, with respect to request performances, latency is a time period between the start event (401, FIG. 4) and end event (402, FIG. 4) while throughput is the number of times the end event was executed during a set amount of time (extrapolated to a second to a value of “request per second”).

In an example embodiment, the contribution (or weight) for the at least one second event that experience the virtual speed up is calculated as below:

$$weight = \frac{predicted time}{actual time}$$

The actual time of the latency may be directly measured as the time between the start and the end event in the single request occurrence. For the throughput performance of the request, the actual time may be measured as a time taken for a preset number of end events (402) to be executed. To this end, the actual time of the request throughput is measured by monitoring a batch of consecutive occurrences of the request exhibiting inherent delays on the same first event in order to determine a contribution (or weight) value for the at least one second event. In an embodiment, the determined contribution value is assigned to all the at least one second events of the request, which are identical and consistent between the consecutive occurrences of the request in the batch.

It should be noted that the actual time measured for the request occurrence displays the change in request performance caused by the inherent delay and corresponding virtual speed ups of the various events in the request. The weight reflects the impact of each of the at least one second event and is determined as a contribution for all of the at least one second event in the particular request occurrence. In an embodiment, the contribution for each of the at least one second event of the request occurrence may be stored in a memory and/or database.

The weight equal to 1 indicates no impact of the virtual speed up at the at least one second event on the request performance. All of the at least one second event is assigned with the weight suggesting that the at least one second event may be an optimized event. A greater deviation of the weight from 1 indicates a larger change of request latency or throughput as a result of the at least one second event. The weight defines a contribution of the at least one second event on the request performance for this occurrence of the request. In some embodiments, the contribution may be determined as a percentage of contribution on the request, again, based on the predicted time and the actual time measured for the request occurrence.

In an embodiment, one round of operations from S320 to S350 determines the contribution of the at least one second event for a single occurrence (latency) or a batch of consecutive occurrences (throughput) of the request. In a further embodiment, such contributions may be continuously determined for every request occurrence that are detected during runtime of the workload. The request occurrences may be monitored and its data may be collected by an agent at the resource (e.g., the agent 125 at the resource 120, FIG. 1).

At S360, event performances are determined for the plurality of events of the request. An event performance is a final contribution (or final weight) of an event on the request performance (e.g., latency, throughput, etc.). In an embodiment, an event performance is determined for each event of the plurality of events through statistical analysis of multiple contributions (S350) of the corresponding event. Thus, a statistically determined event performance is computed for each of the plurality of events in the request, demonstrating the impact of each event on the request performance. It should be noted that the plurality of events includes the first event and the at least one second event, since different events will experience inherent delay at different rounds of request runtime. As an example, event (a) may be a first event that has the inherent delay in one occurrence of the request, but the same event (a) may be a second event that experiences virtual speedup in another occurrence of the request.

In an embodiment, the contributions determined for every request occurrence (each round of S320 to S350) are aggregated based on predefined rules for the statistical analyses. The predefined rules may include criteria for grouping contributions, for example, but not limited to, a single request type, a single event type, a predefined time period, and the like, and any combination thereof. As an example, an event performance for event (1) that is an event in request (A) is determined by performing statistical analysis of 50 contributions for event (1) in occurrences of request (A) over 1 hour. In an embodiment, the aggregated contributions are utilized to determine statistical parameters such as, but not limited to, average, median, maximum, minimum, and the like, and any combination thereof, of an event performance for each event of the plurality of events with respect to the specific type of request. In a further embodiment, the aggregated data may be stored in a database of the analyzer (e.g., the analyzer 130, FIG. 1).

It should be noted that the aggregation of performances over time enables analyses of request performances at various situations. It should be further noted that aggregating the contributions from the plurality of request occurrences (many runtimes of the request) and the statistical analyses eliminates anomalies and/or noises to improve accuracy of event performances. Multiple requests (e.g., same request with same delay, same request with different delay, different request with different delay, or the like, and more) run simultaneously to affect request performances that cause variations when each request occurrences are individually utilized.

At S370, an optimization opportunity is identified. In an embodiment, a specific event may be identified as a bottleneck event upon determination that the difference, of the event performance (i.e., final weight) of the specific event, from 1 is greater than a predefined limit. As described above for individual weights (S350), an event performance (aggregated final weight) of 1 indicates no impact or change on the request performance by the event. Thus, event performances with large deviation from 1 may be identified as optimization opportunities to improve request performance. The large deviation may be defined as an event performance beyond a predefined range. In an example embodiment, the predefined range may be a range above a 75th percentile. As an example, an event is identified as an optimization opportunity when the event performance is at an 80th percentile. In another example, an event is identified as an optimization opportunity when the deviation is at the above 75th percentile range. In an embodiment, the identified optimization opportunity event may be stored in a database of the analyzer (e.g., the analyzer 130, FIG. 1). In an example embodiment, the optimization opportunity event with the largest event performance deviation (i.e., largest contribution on request performance) may be selected to be optimized to improve request performances, for example, but not limited to, to reduce request latency, to increase request throughput (e.g., request-per-second).

It should be noted that the accurate determination of event performances using statistical analysis also improves accuracy and efficiency in determination of optimization opportunities. False positives or negatives may be reduced through reduction of noise and anomalies and analysis of various conditions and situations that occur randomly. It is further noted that the optimization opportunity is determined by exploiting the native randomness of the service that is monitored using an agent (e.g., the agent 125, FIG. 1) without additional modification and processing burden at the resources (e.g., the resources 120. FIG. 1).

FIG. 4 is an example schematic diagram 400 illustrating a request map according to an example embodiment. The example schematic diagram 400 maps a request between a start event 401 and an end event 402. The example request includes two threads 410 and 420 between the start point 401 and the end point 402, where each thread includes at least one event. The first thread 410 includes events 411 through 413 as well as periods between the events (or transfer times) 431 and 432. The second thread 420 includes one event 421. Each event (411 to 413, 421) and periods between the events (431, 432) includes one or more functions that execute the event. The event may be, for example, but not limited to, opening a connection to a socket, opening a file, sending over a network, holding a multi exclusion (mutex) object, waiting on a mutex, sending data over a socket, and the like, and more. An inherent delay 450 at a first event 411 is shown in the example request map 400 for illustrative purposes, but it should be noted the inherent delay is not part of the request map and that the inherent delay can occur at any one of the plurality of events in the request.

The time taken to complete the request from the start event 401 to the end event 402 is a latency of the request. The number of times the request is completed, that is the number of times the end event 402 is detected, per time period is defined as the throughput of the request. The throughput of the request is a rate, for example, requests-per-second. The time taken to output a predefined number of requests is measured to calculate the contribution of the at least one second event on the request performance. In an example embodiment, when the request performance, for example, the latency and the throughput it above a 75th percentile, the event performance is analyzed to identify an optimization opportunity and/or a bottleneck event.

In one example request occurrence (one execution from start 401 to end 402), the inherent delay 450 is detected at the first event 411 on the first thread 410. In such a scenario, the event 421 in the second thread 420 experiences a virtual speedup and is identified as the second event. A contribution of the second event is determined based on a weight calculated between the predicted time and the actual time of the request latency, throughput, and the like, of this request occurrence. Similarly, the contribution of the event 421 may be collected for multiple execution of the request when the event 421 experiences the virtual speed up. Statistical analysis is applied to the collection of contributions with respect to the request and the event 421 to generate an event performance for event 421. In an example embodiment, the event performance may be determined from contributions of the event 421 within a predetermined time period, for example, 15 minutes. In some example implementations, the contribution of the event 421 on the request are grouped for requests that show the inherent delay 450 at event 411.

Event performances may be statistically calculated for each of the events (e.g., 411-413, 421, 431-432) by aggregating contributions of each event from multiple request occurrences (multiple execution from start 401 to end 402 with same or different inherent delays). The event performances indicate the contribution of each event to the overall performance of the request performance. Moreover, the event performance may be utilized to determine the performance of each function executing the event by monitoring the active functions. In an example embodiment, the contribution of each function may be determined based on a call stack and a CPU time to identify a time spent on each function. The event performance and/or the function performance indicating their contribution to the request latency may be utilized to identify the optimization opportunity. As an example, an event (or function) with a performance at the highest percentile and greatest deviation from the corresponding median is determined as the event to focus modification in order to improve request performance. The respective event and/or function may be optimized to remove bottlenecks and improve the request performance, thereby increasing efficiency at the resources (e.g., the resources 120, FIG. 1).

It should be noted that the example request map shows two threads for illustrative purposes and does not limit the scope of the disclosed embodiments. The request includes one or more threads, and each thread includes at least one event.

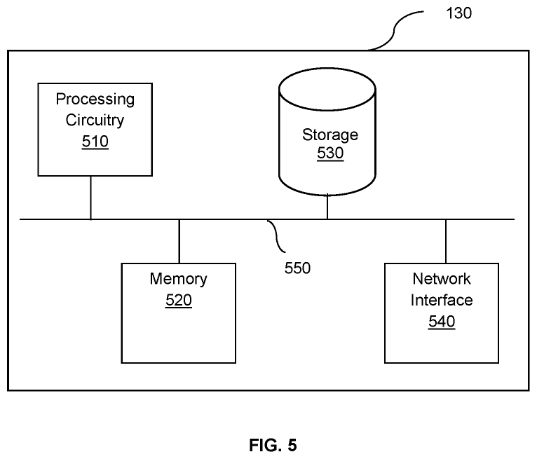

FIG. 5 is an example schematic diagram of an analyzer 130 according to an embodiment. The analyzer 130 includes a processing circuitry 510 coupled to a memory 520, a storage 530, and a network interface 540. In an embodiment, the components of the analyzer 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the analyzer 130 to communicate with, for example, the resources 120, the user device 140, the databases (not shown), and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for determining an optimization opportunity in request performances, comprising:
extracting a first event with an inherent delay and a first thread of a request including the first event, wherein the inherent delay is identified by monitoring a duration of the first event above a threshold percentile;
determining an event contribution for at least one second event that is an event of at least one second thread of the request, wherein the event contribution is determined for a request occurrence;
statistically determining an event performance for each of the at least one second event based on aggregated event contributions for the at least one second event;
identifying an optimization opportunity for the request based on the event performance beyond a predefined range; and
generating a report to include identified optimization opportunity for the request.

2. The method of claim 1, wherein the request is executed by a workload deployed in a cloud computing platform.

3. The method of claim 1, further comprising:
aggregating the event contributions of the at least one second event from a plurality of request occurrences, wherein aggregating is based on a predefined rule.

4. The method of claim 3, wherein the predefined rule includes at least one of: a request type, an event type, and a predefined time period.

5. The method of claim 1, wherein the report includes at least one of: a request performance, an event performance, a bottleneck event, the optimization opportunity, a performance degradation, and potential cost savings.

6. The method of claim 1, further comprising:
mapping the request including a plurality of events, the first thread, and the at least one second thread, wherein the plurality of events includes the first event and the at least one second event.

7. The method of claim 1, wherein the first thread and the at least one second thread are different threads of the request.

8. The method of claim 1, wherein the event contribution is determined as a ratio between a predicted time and an actual time of a request performance.

9. The method of claim 1, wherein the event performance includes at least one of: an average, a median, a maximum, and a minimum.

10. A non-transitory computer readable medium having stored thereon instructions for causing a processing circuitry to execute a process, the process comprising:
extracting a first event with an inherent delay and a first thread of a request including the first event, wherein the inherent delay is identified by monitoring a duration of the first event above a threshold percentile;
determining an event contribution for at least one second event that is an event of at least one second thread of the request, wherein the event contribution is determined for a request occurrence;
statistically determining an event performance for each of the at least one second event based on aggregated event contributions for the at least one second event;
identifying an optimization opportunity for the request based on the event performance beyond a predefined range; and
generating a report to include identified optimization opportunity for the request.

11. A system for determining an optimization opportunity in request performances, comprising:
a processing circuitry; and
a memory, the memory containing instructions that, when executed by the processing circuitry, configure the system to:
extract a first event with an inherent delay and a first thread of a request including the first event, wherein the inherent delay is identified by monitoring a duration of the first event above a threshold percentile;
determine an event contribution for at least one second event that is an event of at least one second thread of the request, wherein the event contribution is determined for a request occurrence;
statistically determine an event performance for each of the at least one second event based on aggregated event contributions for the at least one second event;
identify an optimization opportunity for the request based on the event performance beyond a predefined range; and
generate a report to include identified optimization opportunity for the request.

12. The system of claim 11, wherein the request is executed by a workload deployed in a cloud computing platform.

13. The system of claim 11, wherein the system is further configured to:
aggregate the event contributions of the at least one second event from a plurality of request occurrences, wherein aggregating is based on a predefined rule.

14. The system of claim 13, wherein the predefined rule includes at least one of: a request type, an event type, and a predefined time period.

15. The system of claim 11, wherein the report includes at least one of: a request performance, an event performance, a bottleneck event, the optimization opportunity, a performance degradation, and potential cost savings.

16. The system of claim 11, wherein the system is further configured to:
map the request including a plurality of events, the first thread, and the at least one second thread, wherein the plurality of events includes the first event and the at least one second event.

17. The system of claim 11, wherein the first thread and the at least one second thread are different threads of the request.

18. The system of claim 11, wherein the event contribution is determined as a ratio between a predicted time and an actual time of a request performance.

19. The system of claim 11, wherein the event performance includes at least one of: an average, a median, a maximum, and a minimum.
